(19) United States
(12) Patent Application Publication
(10) Pub. No.: US 2002/0002565 A1
(43) Pub. Date: Jan. 3, 2002

(54) METHOD AND APPARATUS FOR DISPLAYING AN OPERATOR INPUT IN AN IMAGE USING A PALETTE DIFFERENT FROM THE IMAGE PALETTE

(76) Inventor: AKIRA OHYAMA, YOKOHAMA-SHI (JP)

Correspondence Address: A BRUCE CLAY, IBM CORPORATION, DEPT T81 BLDG 062, P O BOX 12195, RESEARCH TRIANGLE PARK, NC, 27709

(21) Appl. No.: 09/003,978

(22) Filed: Jan. 7, 1998

(30) Foreign Application Priority Data
Jan. 7, 1997 (JP) 09-000585

(51) Int. Cl. G09G 5/08; G06F 17/00

(52) U.S. Cl. 707/501.1; 707/507

(57) ABSTRACT

The operator identifies an input field by point and drag operations in an image window while in an edit mode. Upon switching from the edit mode to an input mode, the cursor is set at the first input field. A converted color palette making the whole window grayish is now applied, while a program part of the editor is applied to the current input field. Since the background color of the program part is white, the display appears as if only the current input field is zoomed in for a close-up. When the tab key or the like is pressed, the application of the program part to the current input field is released, and the program part is applied to the next input field. Thus, an operator does not lose sight of the cursor.

### FIELD OF THE INVENTION

This invention is related to a method for displaying data, and particularly to a method for clearly displaying a field on which the current operator input is to be performed.

### BACKGROUND OF THE INVENTION

Conventionally, there has been form print software in which the image of a form printed on a hard copy is inputted, and printed after being combined with characters or the like inputted from a personal computer (PC). In such conventional form print software, a captured form image is displayed on a display device, and input fields for entering data to be combined with the image are defined by specifying squares at desired positions on the image by point and drag operations of a mouse. Then after setting the input fields, the operation of inputting characters or the like to the respective input fields defined on the display screen is performed to combine the image with the characters or the like inputted from the PC.

However, the input fields to be defined on a form image may be scatteringly defined throughout the image depending on the type of the form. Further, an operator unaccustomed to blind touch keying should repeatedly perform the operations of:

1) looking at the screen to check whether or not the cursor is located at the field on which the inputting is made,

2) looking at the document containing data to be inputted.

3) keying in the data while looking at the keyboard, and

4) performing an action such as pressing the tab key for transferring control to the next input field.

In such case, when again looking at the screen after terminating operations 3 and 4 using the keyboard, the operator often loses sight of the position of the cursor having moved to the next input field, causing a reduction of working efficiency. Specifically, when part of a form is enlarged and displayed in a window, this problem will be more serious if the next input field does not exist in the currently displayed window. The reason for this is that, if an operation for transferring control to the next field is carried out, a change (scrolling) of the displayed portion is made to display the next field, and thus it will be more difficult for the operator to keep track of the cursor position. Further, for the above-mentioned form print software, since fields are defined on an inputted bitmapped form image, input fields and squares on the form image may be confused, and thus the operator cannot completely keep track of which field the operator is currently inputting data to.

To solve such problems of the background art, several techniques are now proposed. For instance, in “Sha-Raku-Raku” of Business One Corp. (“Sha-Raku-Raku” is a trademark of Business One Corp.), discriminating display is provided by changing the color of the square frame of a field on which the inputting is currently performed. However, in this method, a display change occurs on the screen only in part of the input field, and accordingly, if the operator pays attention to any other portion, he may not promptly catch the discriminating display of the input field. Furthermore, if an inputted form image is a color image rather than a so-called “black and white”, image, the discriminatingly displayed input field and squares existing in the form image may be confused.

Further, as a technique related to the invention of this application, there is Published Unexamined Patent Application No. 8-6740. This publication discloses a technique for discriminatingly displaying a prescribed print form data representative of the previously printed contents and edit data inputted with the printing position thereof being specified, and for printing them. However, since this technique is directed to a technique for displaying previously inputted data so that it can be discriminated from the from data, it cannot clearly show the position of the input field to which the operator now wants to input data.

### SUMMARY OF THE INVENTION

It is an object of the present invention to provide a data display system for achieving an input operation which is easier to use. It is a further object of the present invention to provide a data display system for clearly displaying the position of the current input field to the operator, thereby to prevent the operator from losing sight of the cursor. It is still a further object of the present invention to provide a data display system which enables the operator to definitely grasp whether or not the current operating mode is an input mode.

In a typical aspect of the present invention, the operator identifies an input field by performing a point and drag operation on an image in an edit mode. Further, switching from the edit mode to the input mode causes the cursor to be set at one of the defined input fields. Now, to the image, a converted color palette is applied for making the whole image grayish, and a program part of the editor is attached to the input field at which the cursor is set. Since the background of the program part is white, this input field is displayed as if only it is zoomed in on for close-ups. The processing of the tab key or the like releases the attachment of the program part to this input field to cause the program part to be attached to the next input field. This allows the operator to definitely keep track of the current input field.

In a further aspect of the present invention, there is provided a method for discriminatingly displaying one input field of a plurality of input fields which exist on an image displayed on a display screen by using a first palette, and each of said input fields corresponding to positional information for identifying a position on the field, the method comprising: a step of detecting an operator input specifying an input mode; a step of selecting one input field of the plurality of input fields; a step of displaying the image on the display screen by using a second palette different from the first palette; a step of applying the positional information corresponding to one input field to an input field edit control; and a step of displaying the input field edit control by a color different from the image displayed by using the first palette.

As used herein, the “image” is a concept which includes not only an inputted bitmapped image but also the background image (also including plain-colored one) of a window, and the image forming a “ground” used in various applications. Further, the “palette” is a concept which includes various data, tables and the like which are used for determining the coloration of an image (including not only a color but also monochrome or the like), and it is a concept which includes a color lookup table and gray scale. Furthermore, the “input field” is not limited to a field to which characters or numerics are inputted, but it is a concept which includes a field to which various information such as graphics information can be entered.

In a further aspect of the present invention, there is provided a method for discriminatingly displaying one input field of a plurality of input fields which are existing on an image displayed on a display screen by using a first palette, and each of said input fields corresponding to positional information for identifying a position on the field, the method comprising: a step of displaying the image on the display screen by using a second palette different from the first palette; and a step of displaying one input field by a color different from the image displayed by using the first palette.

In a further aspect of the present invention, there is provided a method for discriminatingly displaying an input field existing on an image displayed on a display screen, the method comprising: a step of displaying the image in the vicinity of the input field by changing the color thereof; and a step of displaying the input field by a color different from the changed color of the image.

In a further aspect of the present invention, there is provided a data display system for discriminatingly displaying one input field of a plurality of input fields which exist on an image displayed on a display screen by using a first palette, and each of which is made to correspond to the positional information for identifying a position on the field, the data display system comprising: an image displaying unit for displaying the image on the display screen by using a second palette different from the first palette; and an input field edit control for displaying one input field by a color different from the image displayed by using the first palette.

In a further aspect of the present invention, there is provided a data processing system for discriminatingly displaying an input field existing on an image displayed on a display screen, the system comprising: means for displaying the image in the vicinity of the input field by changing the color thereof; and means for displaying the input field by a color different from the changed color of the image.

In a further aspect of the present invention, there is provided a storage medium readable by a computer for storing a program for discriminatingly displaying one input field of a plurality of input fields which exist on an image displayed on a display screen by using a first palette, and each of said input fields corresponding to positional information for identifying a position on the field, the program comprising: program code means for instructing the computer to select one input field of the plurality of input fields; program code means for instructing the computer to display the image on the display screen by using a second palette different from the first palette; program code means for instructing the computer to attach an input field edit control to the positional information corresponding to one input field; and program code means for instructing the computer to display the input field edit control by a color different from the image displayed by using the first palette. The “program code means” in the Claims of this application is a concept which includes not only an object code directly recognizable by a computer, but also an instruction set or the like such as a source code which can be recognized by a computer after being subjected to some conversion.

In a further aspect of the present invention, there is provided a storage medium readable by a computer for storing a program for discriminatingly displaying one input field of a plurality of input fields which exist on an image displayed on a display screen by using a first palette, and each of said input fields corresponding to positional information for identifying a position on the field, the program comprising: program code means for instructing the computer to display the image on the display screen by using a second palette different from the first palette; and program code means for instructing the computer to display one input field by a color different from the image displayed by using the first palette.

In a further aspect of the present invention, there is provided a storage medium readable by a computer for storing a program for discriminatingly displaying an input field existing on an image displayed on a display screen, the program comprising: program code means for instructing the computer to display the image in the vicinity of the input field by changing the color thereof; and program code means for instructing the computer to display the input field by a color different from the changed color of the image.

### BRIEF DESCRIPTION OF THE DRAWINGS

For a more complete understanding of the present invention and for further advantages thereof, reference is now made to the following Detailed Description taken in conjunction with the accompanying drawings, in which:

FIG. 1 is a block diagram showing a hardware configuration of an embodiment of the present invention;

FIG. 2 is a block diagram of the processing elements (structural elements) in accordance with the present invention;

FIG. 3 is a conceptual view of a list structure of a field in accordance with the present invention;

FIG. 4 is a conceptual view of a field data structure in accordance with the present invention;

FIGS. 5-8 illustrate one embodiment of a user interface in accordance with the present invention;

FIG. 9 is an illustration showing another embodiment of a user interface in accordance with the present invention;

FIG. 10 is a schematic view of a template in accordance with the present invention; and

FIG. 11 is a conceptual view of a data structure of a template constructed in accordance with the present invention.

### DETAILED DESCRIPTION OF THE INVENTION

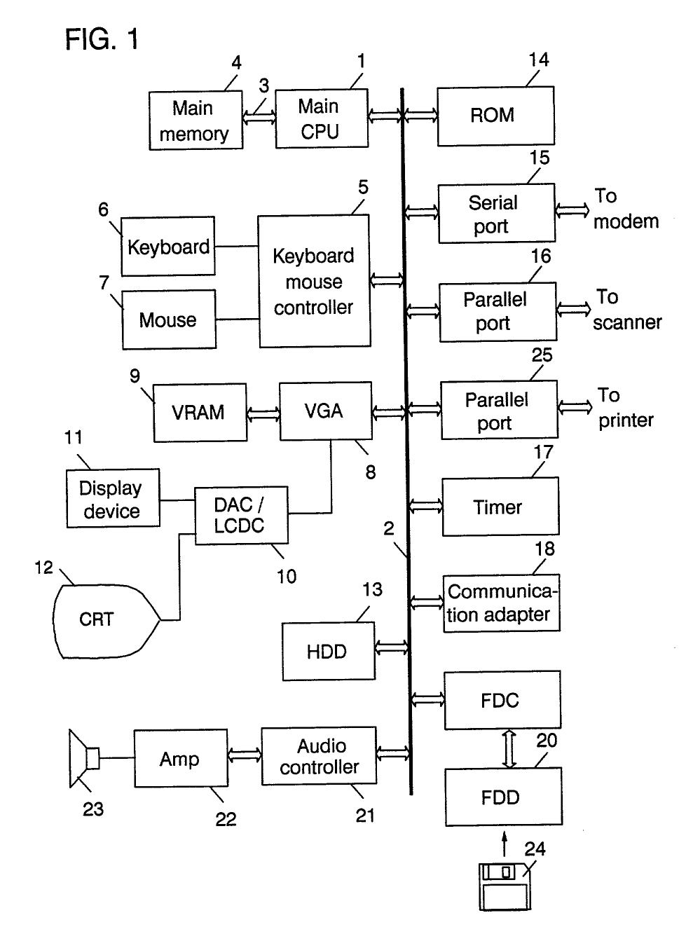

one embodiment of the present invention is described with reference is to the drawings. Referring first to FIG. 1, a schematic block diagram of a hardware configuration for implementing a data processing system in accordance with the present invention is shown including a central processing unit (CPU) 1 and a memory 4. The CPU 1 and the memory 4 are connected to a hard disk drive 13 as an auxiliary storage device through a bus 2. A floppy disk drive 20 (or other device for driving a medium such as MO (Magnet-Optical) or CD-ROM) is connected to the bus 2 through a floppy disk controller 19.

Into the floppy disk drive 20 (or other device for driving a medium such as MO or CD-ROM), a floppy disk 24 (or an MO or CD-ROM) is inserted, and on the floppy disk 24, or the like, the hard disk drive 13, and a ROM 14, the code of a computer program for giving instructions to the CPU 1 in cooperation with an operating system to implement the present invention can be recorded and is loaded into memory for execution. The computer program code may be compressed, or divided into a plurality of pieces and recorded on a plurality of media.

Furthermore, user interface hardware such as a pointing device 7 (mouse, joy stick, track ball or the like) or a keyboard 6, and a display 12 for presenting image data to the user are provided. In addition, a speaker 23 receives an audio signal from an audio controller 21 through an amplifier 22, and outputs it as sound.

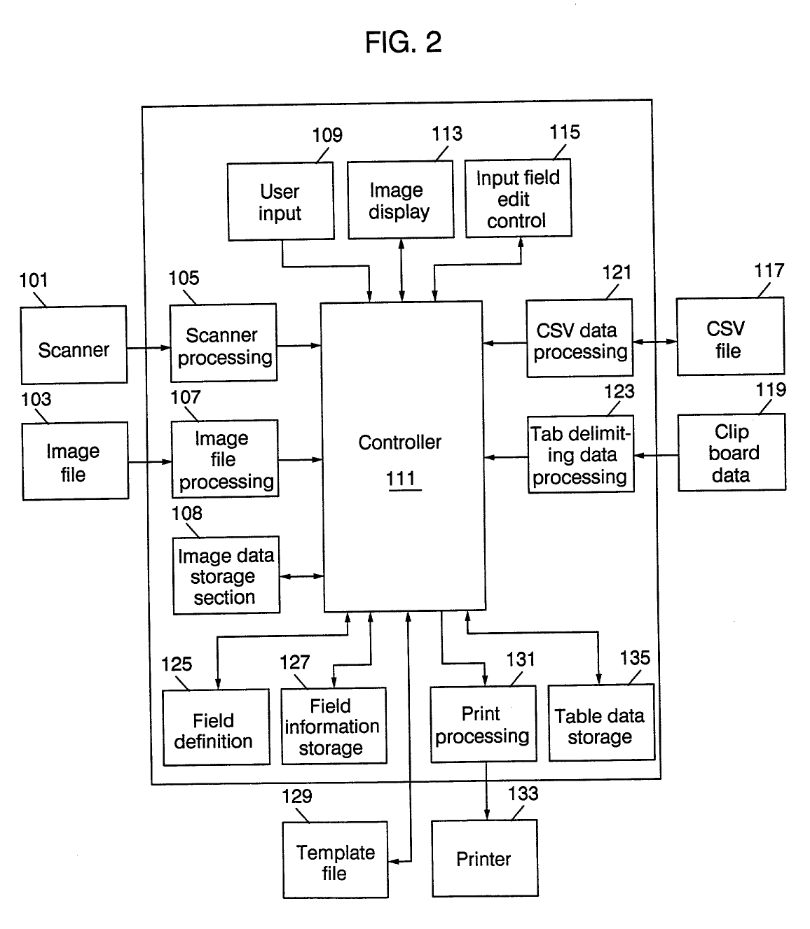

Image data may be created by a scanner 101 (See FIG. 2), and inputted through a parallel port 16. However, the image data created by a scanner 101 may also be inputted through a SCSI interface (not shown) or any other appropriate interface rather than the parallel port 16. Further, communication can be made with another computer or the like through a serial port 15 and a modem, or a token ring or a communication adapter 18 to receive image data, or image data may be received from other input logic such as a floppy disk drive and the like.

Thus, it may easily be understood that the present invention can be implemented by a conventional personal computer (PC) or workstation, a Personal Digital Assistant (PDA), a network computer (NC) or an optical character recognition (OCR) device, or a combination of these. However, these structural elements are exemplary, and not all the structural elements are the indispensable structural elements of the present invention. In particular, since the present invention visually supports an operator, the structural elements such as the serial port 15, communication adapter 18, audio controller 21, amplifier 22, and speaker 23 are not essential.

The operating system is preferably the one which supports a multi window environment, such as Windows 95 (a trademark of Microsoft), Windows 3.x (a trademark of Microsoft), Windows CE (a trademark of Microsoft), OS/2 (a trademark of IBM), or X-WINDOW system (a trademark of MIT) on AIX (a trademark of IBM), but the present invention may be implemented by a single window and is not limited to a GUI environment, and thus it can also be embodied in a character-based environment such as PC-DOS (a trademark of IBM) or MS-DOS ( a trademark of Microsoft). In addition, it can also be implemented by a real time OS such as OS/Open (a trademark of IBM), or VxWorks (a trademark of Wind River Systems, Inc.), and it is not limited to a specific operating system environment.

Further, although a system of a stand-alone environment is shown in FIG. 1, it is also possible that the present invention is embodied as a client/server system in which client machines are connected to a server machine through a LAN such as Ethernet or a token ring network, only a user input unit, image display unit, and input field edit control, which are described later, are disposed on the client machine side, and the other functions are disposed on the server machine side. Thus, functions to be located on the server machine side and client machine side can freely be changed in the design, and various modifications such as combinations of a plurality of machines, and which functions to be distributed to them and implemented are concepts included in the idea of the present invention.

Now, referring to the block diagram of FIG. 2, a system configuration of the present invention is described. In one embodiment of the present invention, a data processing system 100 includes a scanner processing unit 105, an image file processing unit 107, a user input unit 109, a controller 111, an input field edit control 115, a field defining unit 125, a field information storage unit 127, and a print processing unit 131.

In one embodiment of the present invention, form image data is inputted from a scanner 101 or directly from an image file 103 and converted by the image file processing unit 107 into a format which enables the controller 111 to handle both without distinguishing them. In one embodiment of the present invention, the image file processing unit 107 has a function for expanding compressed image data. The image data processed in the scanner processing unit 105 and the image file processing unit 107 are stored in an image data storage section 108.

The user input unit 109 has a function for receiving inputs of instructions to start and end a processing, and input signals from the operator such as inputs of coordinate values on the screen using a pointing device, and transmitting them to the controller 111. The controller 111 controls each functional block shown in FIG. 2 to perform the control of data sending and receiving, and the like. The image display unit 113 merges the form image data stored in the image data storage section 108 and the field information stored in the field information storage unit 127 to display them on a display 11. Further, the image display unit 113 can also merge the form image data contained in a read-in template file 129 with the field information to display them on the display device 11 (See FIG. 1).

The input field edit control 115 is a program part of a text editor which has a size. This program part has a “white” background color as the default.

In one embodiment of the present invention, the field definition 125 field once displays the image data converted by the scanner processing unit 105 and the image file processing unit 107 on the display 11, and detects a field by scanning a straight line contained in the square specified by the operator in the displayed form image. Then, the positional relationships between the portions above, below, left, and right of the field are analyzed to create a list structure of the field, which will be described subsequently, and stored in the field information storage unit 127.

The template file 129 is a file in which the form image, once displayed on the display 11, and the positional information of a field is made to correspond to the form image are stored. The specific contents of it are described later. A print processing unit 131 receives the form image stored in the image data storage section 108 and the field data stored in the field information storage unit 127, converts them to data suitable for print output, and passes them to the printer 133. The specific functions of the respective functional blocks described above are described in detail later.

The respective functional blocks shown in FIG. 2 have been described, but it is not meant that these functional blocks are implemented by a single complete piece of hardware or software, respectively, but they may be implemented by composite or common pieces of hardware or software. In particular, since the controller 111 controls a plurality of functional blocks, it may be implemented as discrete blocks.

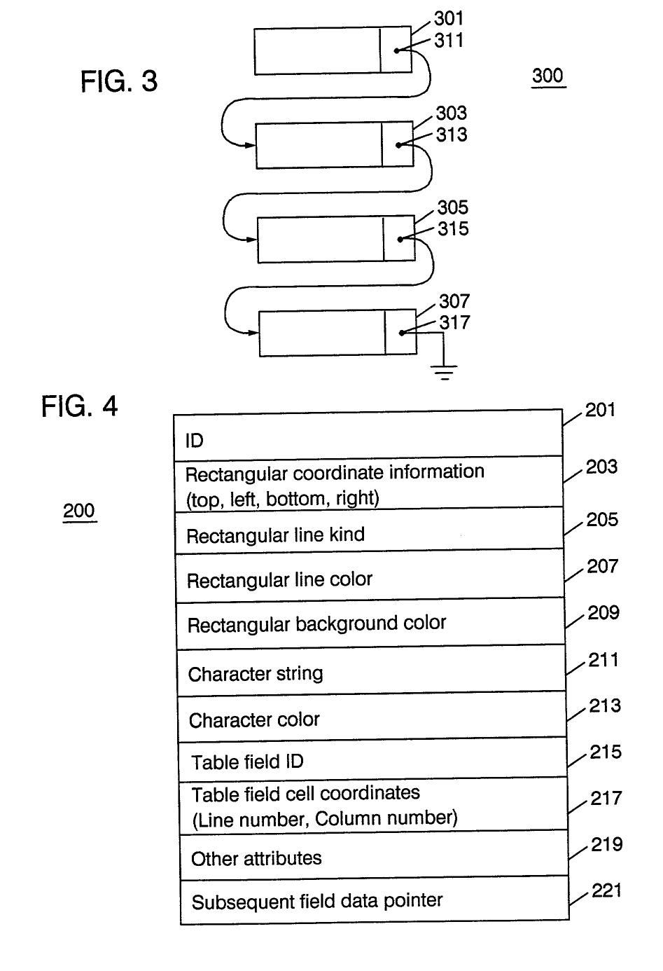

FIG. 3 is a conceptual view of a list structure of a field in one embodiment of the present invention. The field list structure is formed of a plurality of field data structures 301, 303, 305, and 307. The respective field data structures have pointers 311, 313, 315, and 317 pointing to the next field data structure.

FIG. 4 is a conceptual view of each field data structure of FIG. 3. As shown in FIG. 4, each field data structure is created for each cell field contained in a table field and is comprised of ID 201, rectangular coordinate information 203, rectangular line kind 205, rectangular line color 207, rectangular background color 209, character string 211, character color 213, table field ID 215, table field cell coordinates 217, other attributes 219, and a subsequent field data pointer 221.

ID 201 is a numeric unique to the particular field data structure, which is automatically allocated by the system. Rectangular coordinate information 203 is information for identifying the position of the square frame forming the cell field contained in the field defined on the form image by the user.

Character string 211 is a character string inputted to the field. Table field ID 215 is a numeric allocated to each table field. Table fields include a plural-cell table field formed by a plurality of cell fields, and a single-cell table field formed by one cell field.

Table field cell coordinates 217 show a position in the table field in which the cell is existing, and manages the information on line number and column number. Subsequent field data pointer 221 manages an address value pointing to the head of the next field data. When new field data is added, the system automatically sets an address value pointing to the head of the next field data in the entry of the subsequent field data pointer 221 in the current final field data. In the subsequent field data pointer 221 in the newly added field data, information indicating that no next field data exists is set.

In addition, each field data structure can also manage various attributes such as Rectangular line color 207, Rectangular background color 209, Character color 213, and Other attributes 219 (such as information on font and centering).

Although the management entries of a field data structure in the preferred embodiment of the present invention has been described above, this is merely one embodiment, and not all the entries are indispensable structural elements of the present invention. It is only necessary to identify the position of the cell fields constituting a field, and manage information on the table cells linking with the cell fields. In addition, in the preferred embodiment of the present invention, the field data structure is managed by using a linear list, but these pieces of information may be managed by using various approaches such as management by a table, and they are concepts included in the idea of the present invention.

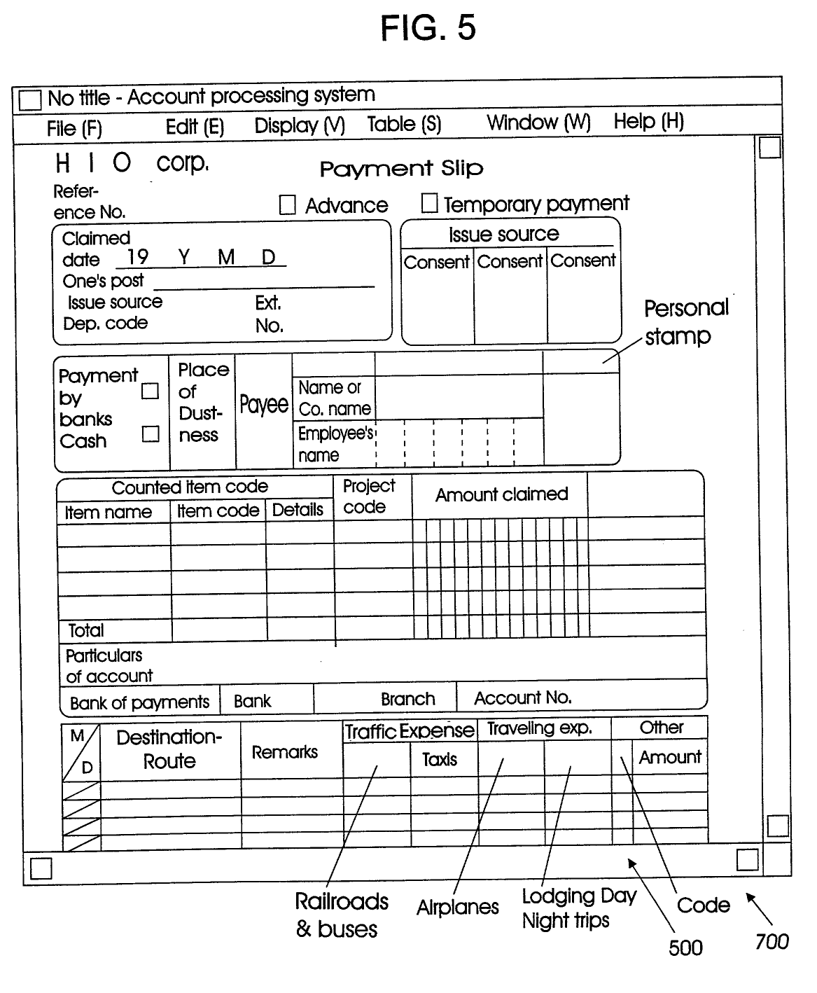

FIGS. 5 to 8 show one embodiment of the user interface in accordance with the present invention. In FIG. 5, in a window 500 on a display screen 700, a form image outputted from the scanner processing unit 105 or the image file processing unit 107 is displayed.

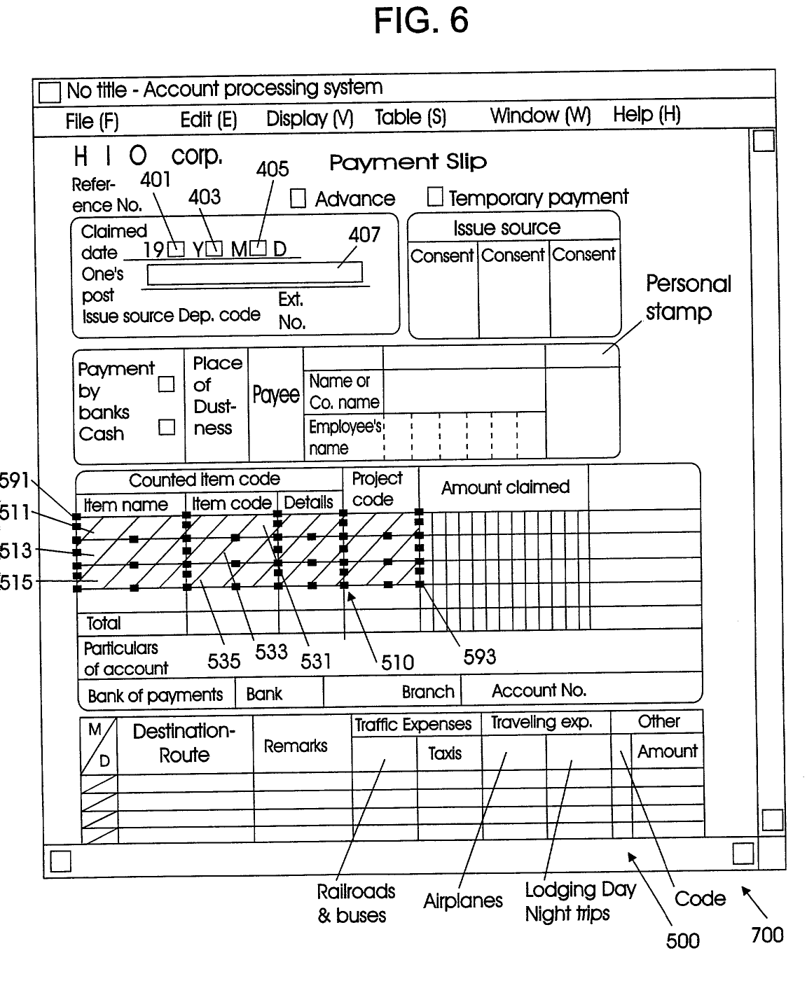

Referring to FIG. 6, an edit mode (a mode enabling the definition of an input field, or the like) is first specified in a pull-down menu to define a portion of the field 510 (table field) contained in the form image displayed in the window 500. Such setting for switching to the edit mode can also be performed by clicking an icon representing the edit mode, or entering a command from the keyboard.

Then by a point and drag operation of a mouse pointer, an operator specifies the upper-left and lower-right portions of the frame to define fields 401, 403, 405, and 407. Further, the operator clicks a point 591 with the mouse pointer and drags the mouse pointer to a point 593 to specify a frame surrounding this table. When the frame is specified by the operator, the scanning of a straight line is performed by the field definition unit 125 (FIG. 2) to detect the positional information on each cell field.

Specifically, the equation (x-coordinate value or y-coordinate value) of vertical and horizontal straight lines is detected by a straight line scanning program, and this allows the calculation of the coordinate values of the vertexes of the frame forming each cell field (the coordinate values of the intersection points of vertical and horizontal straight lines), by which the data processing system 100 (field definition unit 125) can keep track of the positional information of each cell field. Since such approach for recognizing fields contained in an operator specified frame is well known among those skilled in the art, the detailed description thereof is omitted.

There are many such approaches for defining fields or cell fields corresponding to positions on a displayed form image, and those skilled in the art can freely select them. For instance, there is also a method in which fields and cell fields are defined by clicking the insides of a cell field 511 and a cell field 515 with a mouse, scanning the image leftward, rightward, upward and downward from the two clicked points to detect the inner walls of the black frames, and setting a rectangle between two character frames and taking a histogram, thereby automatically detecting the number of character frames within a field, the thickness of the black line between the character frames, and the like.

When a field (one cell field contained in a plural-cell table field or a single-cell table field) is recognized, the field definition unit 125 creates the positional information on the data structures 200 (see FIG. 4) of the fields corresponding to the respective cell fields. In the example shown in FIG. 6, sixteen structures (of the four fields of single-cell table fields, and twelve fields contained in one plural-cell table field) are created. For instance, for a cell field 533, “11” is set in the ID 201 (in this example, ID numbers are assigned from the upper row and from left to right), “0290050803300528” is set in the coordinate information of rectangular coordinate information 203 (the numbers of dots of the x-coordinate value and y-coordinate value of the upper-left vertex, and of the x-coordinate value and y-coordinate value of the lower-right vertex, both in four digits), “01” is set in the table field ID 215 (representing the first table field defined by the operator), “0203” is set in the cell coordinate of table field 217 (the row and column in which the cell exists in the table field, both in two digits), and “00000800” is set in the subsequent field data pointer field 221 (an address value for pointing to a cell 583).

In one embodiment of the present invention, for ID 201, numbers are assigned in the order of creation. Further, for a plural-cell table field, ID 201 numbers are assigned from the top row and from left to right. The order of the IDs 201 may be changed as desired by the operator by a utility which is widely known among those skilled in the art. In addition, the above described information for defining a frame may be information on the x-coordinate values and y-coordinate values of the upper-left vertex, and the cell field width and height, rather than the x-coordinate value and y-coordinate values of the upper-left vertex, and the cell field width and height, rather than the x-coordinate value and y-coordinate value of the upper-left vertex, and the x-coordinate value and y-coordinate value of the lower-right vertex.

Further, the values for the type of rectangular line kind 205, rectangular line color 207, rectangular background color 209, character string 211, character color 213, and other attributes 219 are initialized. When a list of structure for a field such as shown in FIG. 3 is created, such information is stored in the field information storage unit 127 (FIG. 2).

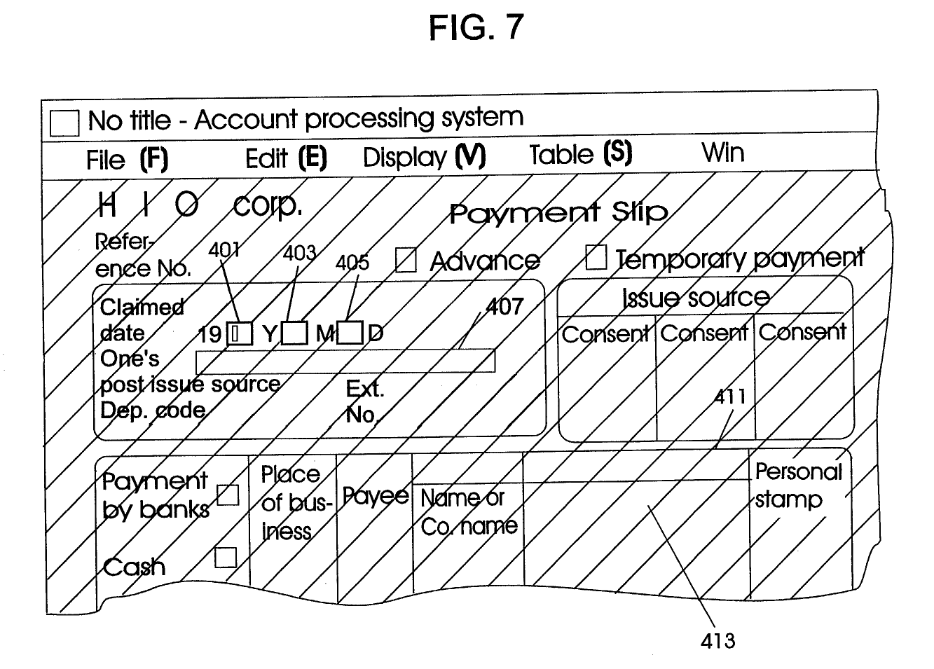

Then, in FIG. 7, the operator performs a change from the edit mode to the input mode. In the preferred embodiment of the present invention, the setting of switching to the input mode is specified in a pull-down menu, as in the case for the edit mode. Such setting of switching to the input mode can be performed not only by a pull-down menu, but also by clicking an icon representing the input mode or inputting a command from the keyboard.

When information instructing the setting of the input mode is inputted to the Controller 111 from the User input unit 109, the Controller 111 detects this and instructs the image display unit 113 to carry out a color palette conversion. In one embodiment of the present invention, by changing a gray scale having a width of 0 to 255 to that having a width of 15 to 240, “white” is changed to “whitish gray,” and “black” is changed to “blackish gray.”

In one embodiment of the present invention, in order to focus on the inside of an input field, the inside of the input field is set to “white” while the remaining portion is set to “gray.” However, by selecting various types of color palettes, a desired image such as a “reddish color” or a “yellowish color” may be displayed. Further, the inside color of an input field can also be freely changed by setting a program part. Thus, what colors the image side and the input field side are set to, and how they are combined are matters which can freely be selected by those skilled in the art, and these are concepts included in the idea of the present invention.

Moreover, a technique for defining a plurality of areas in one window and applying different color palettes to the respective areas is widely known among those skilled in the art, and by applying this technique to the present invention, it is possible to apply the effect of “gray” only to a certain area (for instance, a circle having a radius of 5 cm) or the like around the input field at which the cursor is currently set.

Then, the Controller 111 determines at which input field the cursor is to be set. In one embodiment of the present invention, the default specification sets the cursor at an input field whose ID 201 has a value of “1.” However, if the setting operation of an input field having, for instance, an ID=5 has been performed in the edit mode just before the switching to the input mode, this ID number is held and the setting is performed so that the cursor is set at the input field whose ID 201 has a value of “5.”

Then, access is made to the structure 200 of the input field having the determined ID number to get the coordinate information 203 of the input field. This value is set in the input field edit control 115 which is a program part, and the input field edit control 115 is displayed. Since the background (inside of the frame) of the input field edit control 115 is set to white, the inside of the input field edit control 115 appears to be isolated from the grayish screen as a whole.

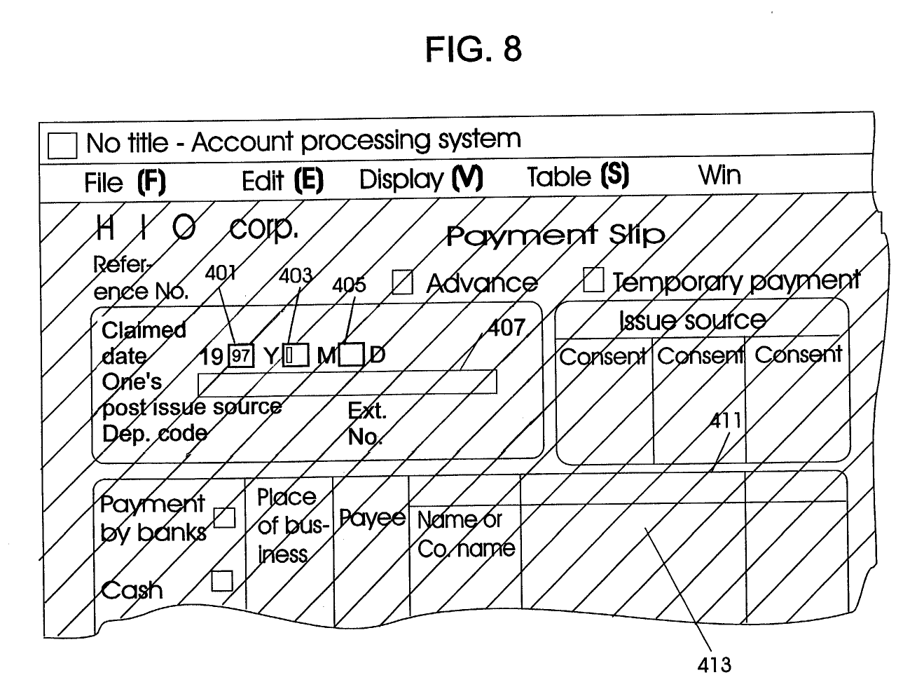

When the operator enters numerics to an input field 401 and presses the Enter key, that information is transmitted to the Controller 111 via the user input unit 109, and the next field is brought into focus as shown in FIG. 8. This procedure is initiated by the Controller 111 detecting an input meeting the exit condition. The exit condition may be detecting the tab key, detecting that a predetermined number of characters or the like have been entered to an input field, clicking any other input field with a mouse pointer, or the like in addition to the above described detection of the Enter key.

If the input meeting the exit composition is detected, the Controller 111 determines the next input entry to be brought into focus. If the Enter key, tab key or the like is pressed, the current ID number plus one is made to go to the next input field. In one embodiment of the present invention, if the current input field is the final input field and there is no input field having a value of the ID number plus one, the input field whose ID number=“1” is the next input field.

If any other input field is clicked with the mouse pointer, the clicked coordinate values are compared with the coordinate information of coordinate information 203, and the input field satisfying the condition of (bottom <y-coordinate of the clicked point <top and left <x-coordinate of the clicked point<right) is made to be the next input field.

When the next input field is determined, the currently displayed input field edit control 115 is erased, and a new input field edit control 115 in which the coordinate information 203 of the next input field is set is displayed. By this, the input field 401 is displayed in gray as shown in FIG. 8, the operator feels as if only the input field 403 is brought into focus. This grayish image is displayed over the whole screen (window), and thus, even if one input field and the next input field are at positions which are rather distant from each other, the operator can easily find the position of the next input field. Further, the frames 411, 413, etc. can be clearly distinguished from input fields.

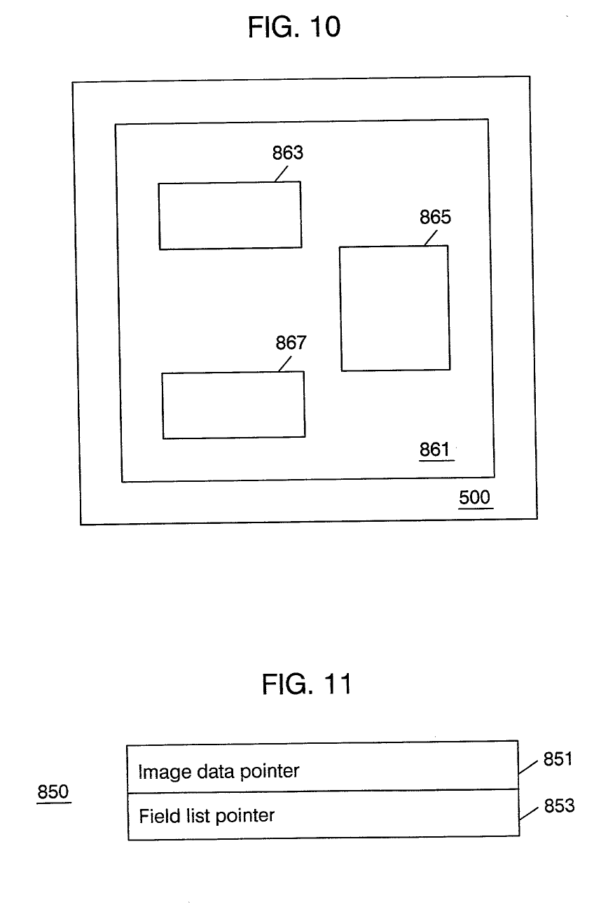

As an additional function of the present invention, image data, and field information attached to the image data can be saved as a template. FIG. 10 is a schematic representation of an image window 500 displayed on the display screen. In FIG. 10, a plurality of fields 863, 865, and 867 are made to correspond to an image 861.

The operator can use the pull-down menu to give instructions to save the image and the fields so that the image and the fields are related to each other, and can attach a template name to them and save them in the template file unit 129 which allows the templates to be recalled by specifying the name thereof. The instructions by the operator to relate the image and the fields to save them may be variously modified and implemented, as long as they are in a form which the system can recognize as a command. For instance, it is possible to prepare an icon for saving a template, generate a command when it is clicked, and relate and save the currently displayed image and fields, or to receive an operator input for giving instructions to save a template from a command input entry allowing a keyboard input by the operator.

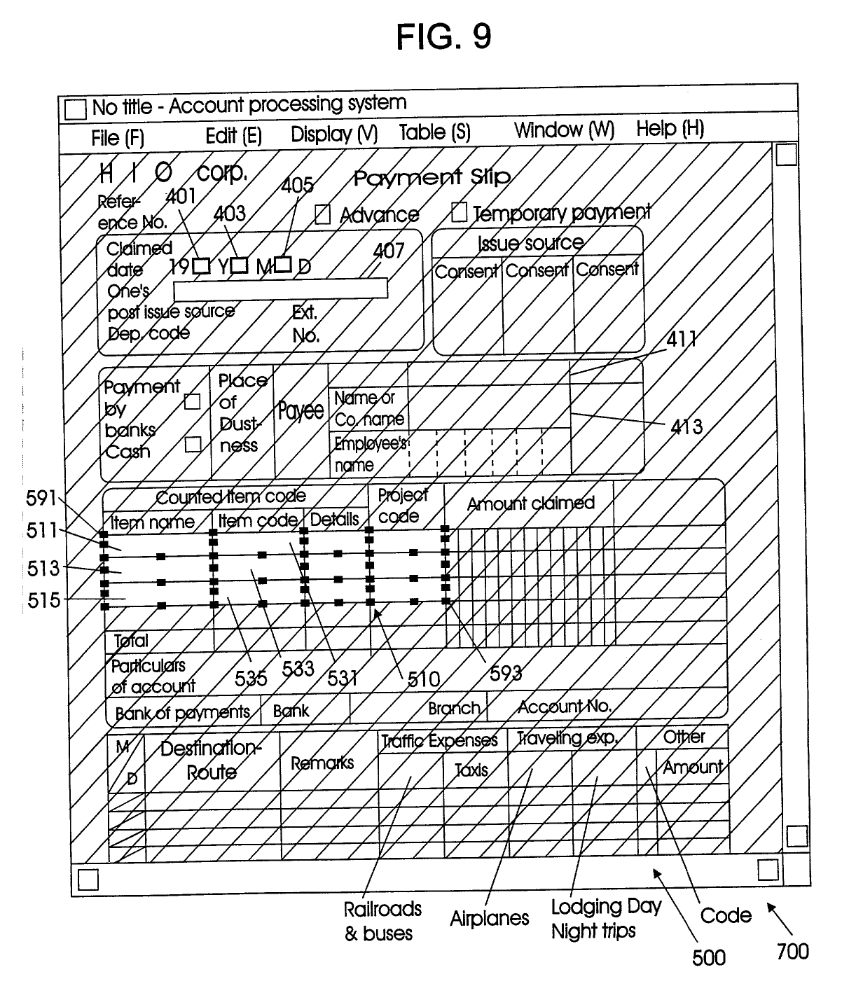

FIG. 9 shows another embodiment of the present invention. In this embodiment, not only the input field at which the cursor is presently set, but also all the input fields are being brought into focus. That is, a preset color is specified and displayed in the portions of all the input fields which are surrounded by a frame, and the input field edit control 115 is set only in the input field at which the cursor is presently set, and displayed by a color different from the other input fields.

FIG. 11 is a conceptual view of the data structure of a template in one embodiment of the present invention. The template 850 manages a Field list pointer 853 for accessing the list of a field, as described in FIG. 4, as well as an Image data pointer 851 to image data. Accordingly, an operator may be immediately put in the input mode after calling the template, and bring a specific input field into focus.

It is an advantage of the present invention that a data display system can be provided in which the position of the current input field is clearly displayed to the operator, thereby preventing the operator from losing sight of the cursor. Further, a data display system can be provided in which the operator can intuitively grasp whether or not the current operation mode is an input mode.

Although the present invention has been described with respect to a specific preferred embodiment thereof, various changes and modifications may be suggested to one skilled in the art, and it is intended that the present invention encompass such changes and modifications as fall within the scope of the appended claims.

What is claimed:

1. A method for discriminatingly displaying one input field of a plurality of input fields existing on an image displayed on a display screen by using a first palette, each of said plurality of input fields corresponding to positional information for identifying a position on each of said plurality of fields, comprising the steps of:
(a) detecting an operator input specifying an input mode;
(b) selecting one input field of said plurality of input fields;
(c) displaying said image on said display screen by using a second palette different from said first palette;
(d) applying positional information corresponding to said one input field to an input field edit control; and
(e) displaying said input field edit control by a color different from the image displayed by using said first palette:

2. A method for discriminatingly displaying one input field of a plurality of input fields which exist on an image displayed on a display screen by using a first palette, each of said plurality of input fields corresponding to positional information for identifying a position thereon, comprising the steps of:
(a) displaying said image on said display screen by using a second palette different from said first palette; and
(b) displaying said one input field by a color different from the image displayed by using said first palette.

3. A data display system for discriminatingly displaying one input field of a plurality of input fields which exist on an image on a display screen by using a first palette, each of said plurality of input fields corresponding to positional information for identifying a position thereon, comprising:
(a) an image displaying unit for displaying said image on said display screen with a second palette different from said first palette; and
(b) an input field edit control for displaying said one input field with a color different from the image displayed by using said first palette.

4. A storage medium readable by a computer for storing a program for discriminatingly displaying one input field of a plurality of input fields which exist on an image on a display screen by using a first palette, each of said plurality of input fields corresponding to positional information for identifying a position on said field, comprising:
(a) program code for instructing said computer to select one input field of said plurality of input fields;
(b) program code for instructing said computer to display said image on said display screen using a second palette different from said first palette;
(c) program code for instructing said computer to attach an input field edit control to the positional information corresponding to said one input field; and
(d) program code for instructing said computer to display said input field edit control by a color different from the image displayed by using said first palette.

5. A storage medium readable by a computer for storing a program for discriminatingly displaying one input field of a plurality of input fields which exist on an image on a display screen by using a first palette, each of said plurality of input fields corresponding to positional information for identifying a position on each of said plurality of input fields, comprising:
(a) program code for instructing said computer to display said image on said display screen using a second palette different from said first palette; and
(b) program code for instructing said computer to display said one input field with a color different from the image displayed by using said first palette.
